(19) United States
(12) Patent Application Publication
(10) Pub. No.: US 2022/0400352 A1
(43) Pub. Date: Dec. 15, 2022

(54) SYSTEM AND METHOD FOR 3D SOUND PLACEMENT

(71) Applicant: Sound Particles S.A., Leiria (PT)

(72) Inventor: Nuno Fonseca, Leiria (PT)

(21) Appl. No.: 17/345,164

(22) Filed: Jun. 11, 2021

(51) Int. Cl. H04S 7/00; G06F 3/0484; G06F 3/16; G06F 3/0488

(52) U.S. Cl. CPC H04S 7/303; G06F 3/04847; G06F 3/165; G06F 3/0488

(57) ABSTRACT

A phone app is disclosed that enables a user to place 3D sound in a room. The user of this app is able to locate precisely where sound is perceived to originate by aiming their phone. This app may be used by audio professionals in place of the controls on a traditional sound mixer.

### BACKGROUND

Limitations and disadvantages of conventional approaches to 3D sound placement will become apparent to one of skill in the art, through comparison of such approaches with some aspects of the present method and system set forth in the remainder of this disclosure with reference to the drawings.

### BRIEF SUMMARY

A system and method for 3D sound placement is disclosed substantially as illustrated by and/or described in connection with at least one of the figures, as set forth more completely in the claims.

### BRIEF DESCRIPTION OF THE DRAWINGS

FIG. 1 illustrates an exemplary environment for 3D sound placement in accordance with aspects of this disclosure.

FIGS. 2 and 3 illustrate an example of selected 3D sound positions relative to a mobile device in accordance with aspects of this disclosure.

FIG. 4 illustrates a first exemplary system for 3D sound positioning in accordance with aspects of this disclosure.

FIG. 5 illustrates a second exemplary system for 3D sound positioning in accordance with aspects of this disclosure.

FIG. 6 illustrates a main screen of a third exemplary system for 3D sound positioning in accordance with aspects of this disclosure.

FIG. 7 illustrates a settings screen of the third exemplary system for 3D sound positioning in accordance with aspects of this disclosure.

FIG. 8 is a flow diagram illustrating an exemplary method for 3D sound positioning in accordance with aspects of this disclosure.

### DETAILED DESCRIPTION

3D sound allows a listener to perceive sound as coming from multiple directions. 3D sound formats (e.g., Dolby Atmos and Ambisonics) are used in movies, TV shows, videogames, and music. Traditionally, audio professionals control the position of the perceived sound sources using either a mixer with knobs and/or joysticks, or using a mouse with a computer.

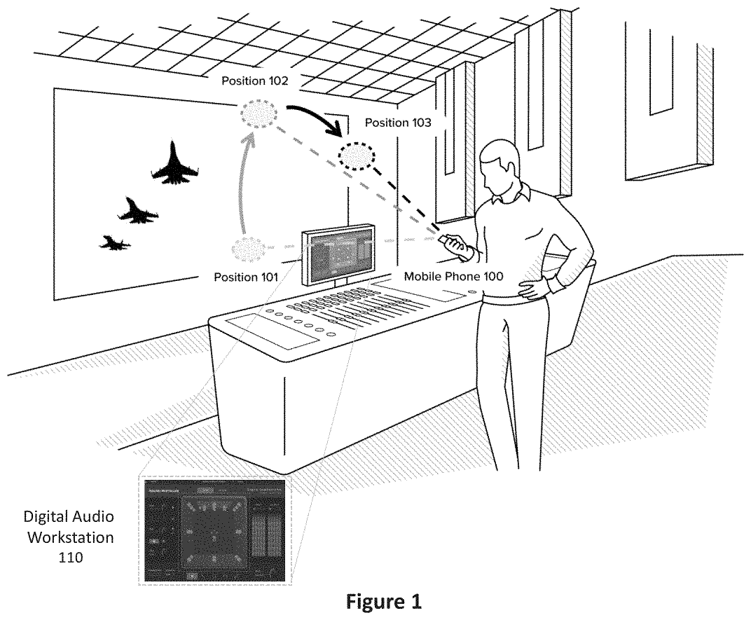

FIG. 1 illustrates an exemplary environment for 3D sound placement in accordance with aspects of this disclosure. While FIG. 1 illustrates an actual studio, the disclosed system for placing sound may be used in any environment. The environment may also utilize virtual and/or augmented reality.

The disclosed system for placing sound uses a mobile device 100, such as a smartphone. The position and motion of the smartphone 100 is determined according to sensors (e.g., accelerometer, gyroscope, magnetometer, camera, LiDAR, GPS) within the smartphone 100.

The smartphone 100 may also be coupled to a laser pointer to show a user where the sound is actually being placed.

The device will take into consideration, not only the initial and final position, but the entire movement between them. For example, the smartphone 100 can start as position 101 and move over time to position 102 and then to position 103, etc. . . . The plurality of 3D positions 101, 102 and 103 indicates a desired location for a perceived point-of-origin of a recorded sound source.

The positioning may occur on-the-fly via feedback to an audio software running on computer (e.g., Digital Audio Workstation (DAW), audio plugin) 110 that controls the sounds that are sent to the speakers.

The sound may be played from the DAW 110 or, alternatively, from a local file while the user steers the sound around a room. The effects of a user's positioning may be heard in real-time, while adjusting the signals sent to the various speaker inputs. Alternatively, another configuration may feedback repositioned sound on-the-fly via headphones (not shown) using Head Related Transfer Functions (HRTF's).

As illustrated, a video presentation may be displayed to synchronize on-screen action with sound placement in a room.

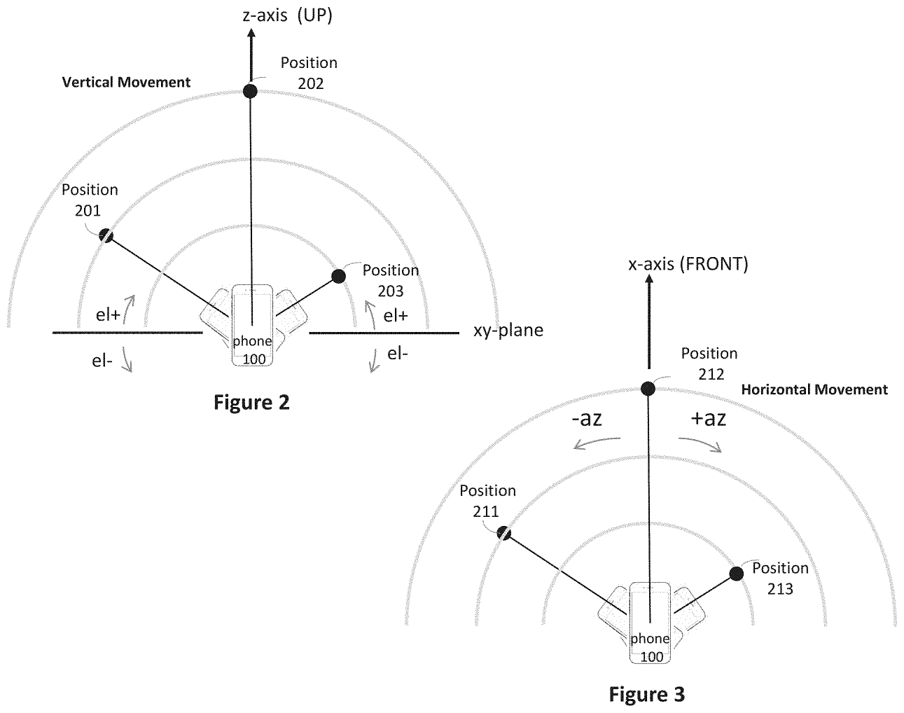

FIGS. 2 and 3 illustrate an example of selected 3D sound positions relative to a mobile device in accordance with aspects of this disclosure. The accelerometer, gyro and magnetometer sensors of a smartphone 100 may be recoded to give the position of the device over time.

FIGS. 2 illustrates the location of points 201, 202 and 203 in terms of elevation and proximity. FIGS. 3 illustrates the location of points 211, 212 and 213 in terms of azimuth and proximity. These orientations of the smartphone 100 may also be described in terms of yaw, pitch and roll. These positions are determined by a smartphone 100 according to sensors and/or augmented reality.

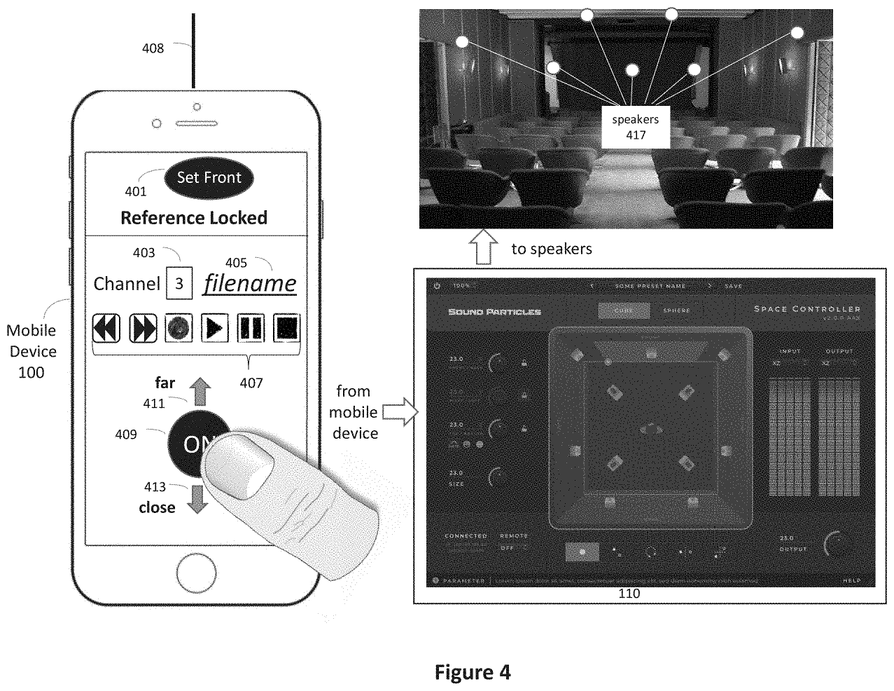

FIG. 4 illustrates an exemplary system for 3D sound positioning in accordance with aspects of this disclosure. The smartphone 100 may be coupled (via Bluetooth or Wi-Fi for example) to an audio plugin, running on the DAW 110.

The DAW 110 uses sound-position data to adjust the sound on the correct channels. The adjusted sound is sent to the appropriate speakers 417. The DAW 110 can also use the sound-position data to control the sound indirectly, using metadata (e.g. Object metadata in Dolby Atmos).

The phone app may enable an input button 401, on a graphical user interface (GUI), for setting the position of a known location for calibration purposes (e.g. for specifying the front).

The user is able to select at 403 one of a plurality of transmission channels (e.g. channels 1 . . . 4) to control different tracks or channels. A smartphone 100 may control multiple sound sources. For example, channel 1 controls the position of the guitar, channel 2 controls the position of the piano, channel 3 controls the position of the drum, etc . . . A user may also use two smartphones at the same time—one on each hand, to control the position in the 3D space of the Left and Right channel.

Alternatively to the transmission channels, the system may use bidirectional communication. Bidirectional communication may allow the user to control directly, from the app, which track (e.g., “Piano 1”) or which audio channel (e.g., “Left”, “Right”) to control. Bidirectional communication may also allow the user to control other parameters or actions from the app (e.g., start playback of DAW).

Alternatively to the DAW 110, the device 100 can work in a standalone mode, where each sound-position recording can be stored (and recalled) by filename 405. A selected sound-position file may be controlled 407 to locate in time where the 3D positioning is required. A time and position data may be reversed, forwarded, (re)recorded, played, paused and stopped.

The phone app may be used in a pointing mode. An optional light/laser 408 may be used to point to the sound-positions.

The user may control when the positioning occurs by pressing a button 409. The system may also send touch begin/end messages to better control parameter automation on the DAW. The relative, perceived distance may also be controlled by sliding up 411 to move a sound farther away or down 413 to move a sound closer.

When using an optional light/laser 408, the system may allow the user to improve its precision by asking the user to better calibrate the device, by pointing to the 4 corners of the video screen, to better calibrate the device with the used screen.

The phone app may also use Bluetooth beacons to better track the position of the mobile device 100 within the room. The beacons can be set on special room positions (e.g. 8 corners of the room), on the speaker locations (e.g. each speaker on the studio), or any other place that may improve the precision of the system.

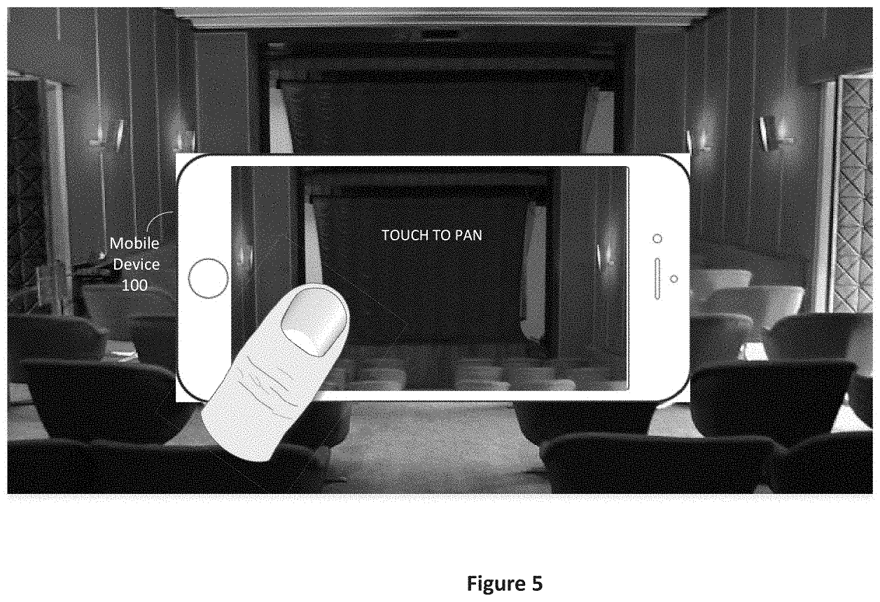

FIG. 5 illustrates another exemplary system for 3D sound positioning in accordance with aspects of this disclosure. The phone app may alternatively (or additionally) be used in an augmented reality mode. A user can touch the screen to specify the position of the sound source. The user can also move the phone to show any space in a room.

The user may complement the motion sensors with a phone's camera and/or LiDAR scanner to improve space resolution. The use of a phone's camera and/or LiDAR scanner may be independent of an AR mode).

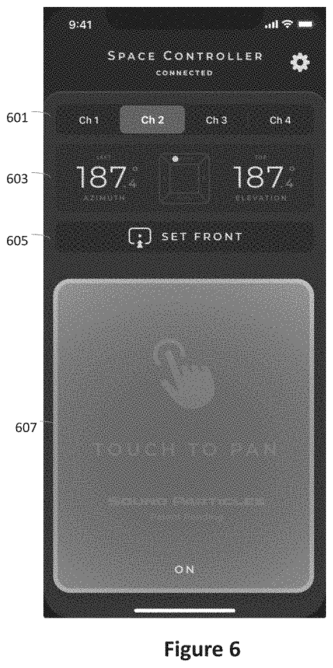

FIG. 6 illustrates the main screen of another exemplary system for 3D sound positioning in accordance with aspects of this disclosure.

In section 601 of the GUI, the user is able to select one of a plurality of channels (e.g. channels 1 . . . 4) to control different tracks or channels.

In section 603 of the GUI, the user is given feedback on where the mobile device is pointing. For example, the azimuth and elevation of the location relative to the mobile device are displayed. An indication of an approximate location in a room (e.g., relative to front, rear, left or right walls) may also be displayed.

In section 605 of the GUI, the user may set (or reset) the position of a known location for calibration purposes (e.g. the front center [az=0^{o}, el=0^{o}]).

The user may control when the positioning begins by pressing a button 607 of the GUI.

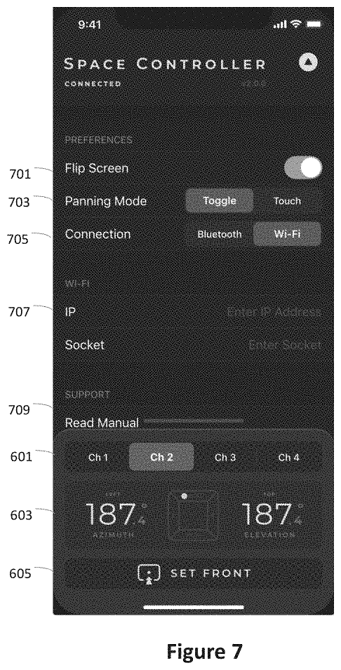

FIG. 7 illustrates a settings screen for a 3D sound positioning system in accordance with aspects of this disclosure.

In section 701 of the GUI, the user is able to select whether the mobile device uses flip screen (e.g. if the laser pointer is located on the bottom of the device, forcing the user to use the device upside down).

In section 703 of the GUI, the user is able to select between toggle and touch mode. In toggle mode, the position recording continues automatically when the screen is touched once and stops when the screen is touched again. In touch mode, the position recording occurs only when the screen is touched.

In section 705 of the GUI, the user is able to set whether the mobile device communicates, via Bluetooth or WiFi to the DAW. If WiFi is selected, additional information may be requested (e.g. an IP address and socket can be entered in section 707).

In section 709 of the GUI, the user is able to find support (e.g., via a manual or online forum).

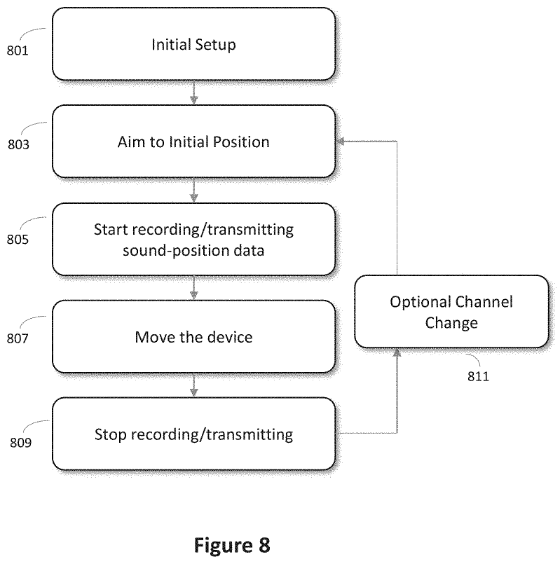

FIG. 8 is a flow diagram illustrating an exemplary method for 3D sound positioning in accordance with aspects of this disclosure.

At 801, a user setups the device, including choosing and setting up the connection with the DAW/plugin (e.g. Bluetooth, Wi-Fi), choosing the initial channel, and setting the reference point.

At 803, the user aims the mobile device to an initial position to begin the 3D positioning.

At 805, the device can start transmitting (OR recording) sound-position data.

At 807, the user may move the device to indicate the desired movement.

At 809, the user may stop the transmission/recording.

After 809, the user can move to another channel 811 and/or another scene.

While the present system has been described with reference to certain implementations, it will be understood by those skilled in the art that various changes may be made and equivalents may be substituted without departing from the scope of the present system. In addition, many modifications may be made to adapt a particular situation or material to the teachings of the present disclosure without departing from its scope. Therefore, it is intended that the present method and/or system not be limited to the particular implementations disclosed, but that the present system will include all implementations falling within the scope of the appended claims.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise first “circuitry” when executing a first one or more lines of code and may comprise second “circuitry” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

1. A non-transitory computer readable medium having stored thereon software instructions that, when executed by one or more processors, enable a user to:
calibrate a mobile device according to a reference location that is external to the mobile device, wherein the reference location is a fixed location that is known a priori;
locate a plurality of 3D positions by moving the mobile device in different directions, wherein each of the plurality of 3D positions indicates a desired location for a perceived point-of-origin for a sound source; and
transmit the plurality of 3D positions with an associated time reference.

2. The non-transitory computer readable medium of claim 1, wherein the software instructions enable the user to calibrate, via a graphical user interface (GUI), a position and an orientation of the mobile device.

3. The non-transitory computer readable medium of claim 1, wherein the software instructions are operable to place the plurality of 3D positions according to the reference location.

4. The non-transitory computer readable medium of claim 1, wherein the software instructions enable the user to play the sound source from a plurality of speakers external to the mobile device.

5. The non-transitory computer readable medium of claim 4, wherein the sound source is perceived to come from each of the plurality of 3D positions according to time.

6. The non-transitory computer readable medium of claim 5, wherein the software instructions, when executed a processor of the one or more processors, controls signal processing of the sound source sent to each of the plurality of speakers such that the sound source is perceived to come from each of the plurality of 3D positions, and wherein the processor of the one or more processors is external to the mobile device.

7. The non-transitory computer readable medium of claim 1, wherein the software instructions, when executed a processor of the one or more processors, stores a data file associated with the sound source, wherein the sound source is prerecorded.

8. The non-transitory computer readable medium of claim 1, wherein locating the plurality of 3D positions by moving the mobile device in different directions comprises pointing the mobile device.

9. The non-transitory computer readable medium of claim 8, wherein the mobile device comprises a laser pointer that illuminates where the mobile device is pointing.

10. The non-transitory computer readable medium of claim 1, wherein locating the plurality of 3D positions by moving the mobile device in different directions comprises:
capturing an image of the user's surroundings, displaying the image on a graphical user interface (GUI), and locating the plurality of 3D positions by touching the GUI.

11. A method, the method comprising: calibrating a mobile device according to a reference location that is external to the mobile device, wherein the reference location is a fixed location that is known a priori;
locating a plurality of 3D positions by moving the mobile device in different directions, wherein each of the plurality of 3D positions indicates a desired location for a perceived point-of-origin for a sound source; and
recording each of the plurality of 3D positions with an associated time reference.

12. The method of claim 11, wherein the method comprises:
calibrating, via a graphical user interface (GUI), a position and an orientation of the mobile device.

13. The method of claim 11, wherein the method comprises:
placing the plurality of 3D positions according to the reference location.

14. The method of claim 11, wherein the method comprises:
playing the sound source from a plurality of speakers external to the mobile device.

15. The method of claim 14, wherein the sound source is perceived to come from each of the plurality of 3D positions according to time.

16. The method of claim 15, wherein the method comprises:
controlling signal processing of the sound source sent to each of the plurality of speakers such that the sound source is perceived to come from each of the plurality of 3D positions.

17. The method of claim 11, wherein the method comprises:
transmitting a data file associated with the sound source, wherein the sound source is prerecorded.

18. The method of claim 11, wherein locating the plurality of 3D positions by moving the mobile device in different directions comprises pointing the mobile device.

19. The method of claim 18, wherein the mobile device comprises a laser pointer that illuminates where the mobile device is pointing.

20. The method of claim 11, wherein locating the plurality of 3D positions by moving the mobile device in different directions comprises:
moving the mobile device to capture an image of the user's surroundings;
displaying the image on a graphical user interface (GUI); and
locating the plurality of 3D positions by touching the GUI.
